(19) United States
(12) Patent Application Publication
(10) Pub. No.: US 2007/0025488 A1
(43) Pub. Date: Feb. 1, 2007

(54) RAM-DAC for transmit preemphasis

(75) Inventors: Andrew Ho, Palo Alto, CA (US); Fred F. Chen, San Francisco, CA (US); Jared L. Zerbe, Woodside, CA (US)

Correspondence Address: SILICON EDGE LAW GROUP, LLP, 6601 KOLL CENTER PARKWAY, SUITE 245, PLEASANTON, CA, 94566, US

(73) Assignee: Rambus Inc.

(21) Appl. No.: 11/193,916

(22) Filed: Jul. 29, 2005

(51) Int. Cl. H04L 7/00

(52) U.S. Cl. 375/372

(57) ABSTRACT

Described are transmitters with RAM-DAC based pre-emphasis filters that can be updated adaptively without interfering with data transmission. The memory within the RAM-DAC is divided into active and inactive memory locations, in which active memory locations are those to be accessed in the near future, and consequently cannot be updated (written to) at a given time due without inducing a read/write conflict. One embodiment monitors incoming memory addresses to find an adequate time window for a write to take place without a read interference. Another embodiment includes two memory blocks with similar address space, one of which may be updated as the other is used to for data transmission. Some embodiments employ a RAM-DAC with reduced memory size and complexity.

### FIELD OF THE INVENTION

The present invention relates generally to the field of communications, and more particularly to high speed electronic signaling within and between integrated circuit devices.

### BACKGROUND

In a conventional transmission line, skin-effect resistance causes attenuation to increase with frequency. Different frequency components of broadband signals transmitted over transmission lines are thus attenuated by different amounts. On the receive side, the resulting superposition of relatively unaffected low-frequency signal components with attenuated high-frequency signal components causes intersymbol interference (ISI) that degrades noise margins and reduces the maximum frequency at which the system can operate. In effect, a transmitted symbol is received as a weighted sum of neighboring symbols.

Transmit equalizers reduce the impact of ISI by adjusting the signal to be transmitted with the goal that the concatenation of the adjusted signal and the transmission line gives a flat frequency response. Transmit equalization is sometimes referred to as “pre-emphasis” because the transmitter does not really equalize the transmitted signal, but instead distorts the signal to offset the low-pass nature of the associated channel. The signal distortion may emphasize some signal components and de-emphasize others. The desired result is typically an equalized signal at the far end of the channel.

FIG. 1 (prior art) depicts a transmitter 100 that employs a look-up table (LUT) to provide appropriate levels of transmit pre-emphasis. Data Din to be transmitted is serially loaded into a chain of sequential storage elements 105, three in this example, to provide a series of four data symbols D[0:3]. Assuming, for example, that data symbol D[2] is the symbol to be transmitted on a given clock cycle, signals D[1] and D[0] represent the prior two transmitted symbols and signal D[3] represents the next symbol to be transmitted.

Signals D[0:3] are conveyed as addresses to a look-up-table (LUT) 110, typically implemented using a random-access memory (RAM). With reference to FIG. 2 (prior art), the address locations of LUT 110 are preloaded with binary values DAC0-DAC15 representative of the drive strength appropriate for each of the sixteen possible symbol patterns. LUT 110 then conveys the contents of the address location specified by the incoming symbol pattern to a digital-to-analog converter (DAC) 115, which converts the output from LUT 110 into an analog signal Tx to drive the associated channel. The drive strength of transmitter 100 is thus based upon a weighted-average of neighboring symbols. For a detailed discussion of transmitters that employ pre-emphasis to combat ISI, see U.S. Pat. No. 6,542,555 to William J. Dally.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 (prior art) depicts a transmitter 100 that employs a look-up table (LUT) to provide appropriate levels of transmit pre-emphasis.

FIG. 2 (prior art) represents the address locations of LUT 110 of FIG. 1 preloaded with binary values DAC0-DAC 15 representative of drive strengths appropriate for each of the sixteen possible symbol patterns.

FIG. 3 graphically depicts a sixteen-entry LUT 300 with four address inputs controlled by data symbols D[3:0] in the manner discussed above in connection with FIGS. 1 and 2.

FIG. 4 depicts a LUT 400, in accordance with one embodiment, that may be used in transmit pre-emphasis circuitry.

FIG. 5 depicts a transmitter 500 in accordance with another embodiment.

FIG. 6A depicts an embodiment of a transmitter 600 with a pre-emphasis filter that can be updated adaptively without interfering with data transmission.

FIG. 6B is a state diagram 650 summarizing the operation of transmitter 600 of

FIG. 6A in accordance with one embodiment.

FIG. 7A depicts a transmitter 700 in accordance with another embodiment.

FIG. 7B depicts a transmitter 750 in accordance with another embodiment.

FIG. 8 depicts a transmitter 800 that combines features of some of the above-described embodiments to provide both increased memory update speed and conflict avoidance.

### DETAILED DESCRIPTION

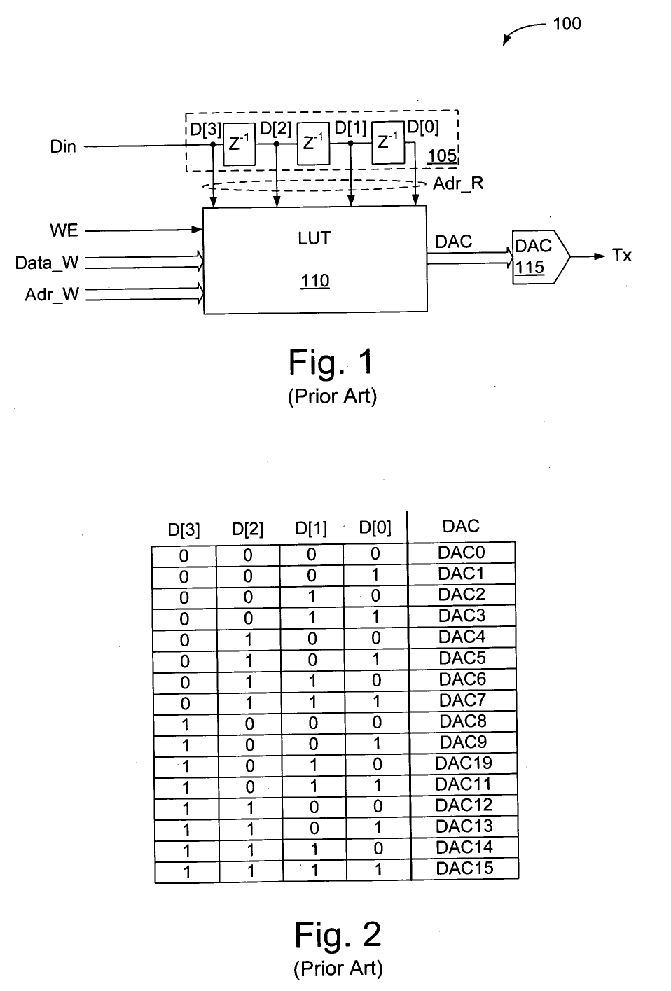

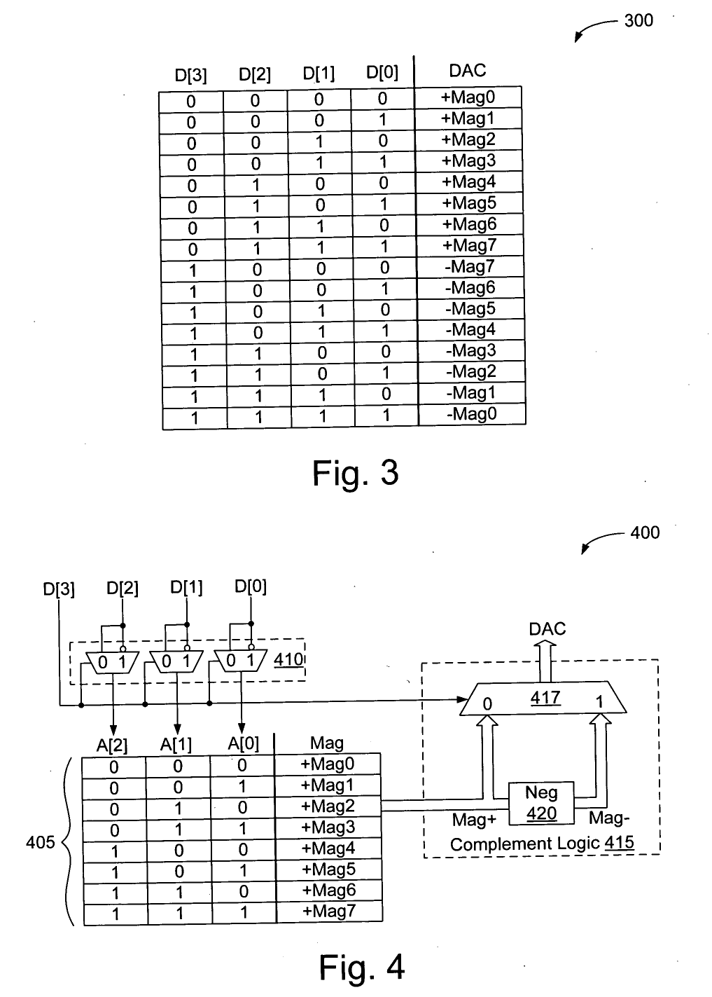

FIG. 3 graphically depicts a sixteen-entry LUT 300 with four address inputs controlled by data symbols D[3:0] in the manner discussed above in connection with FIGS. 1 and 2. The stored values DAC are labeled as positive (+) and negative (−) magnitudes Mag0-Mag7. Applicants noted that the magnitude values were substantially symmetrical for some transmitters. For example, the pre-emphasis required to account for ISI for the pattern 0100 is the same magnitude but opposite polarity as the pre-emphasis required to account for ISI for the pattern 1011. Taking advantage of this symmetry, Applicants devised transmit pre-emphasis circuitry with reduced memory size and complexity.

Conventional filters delay the input data in successive stages to obtain a series of delayed signals. The individually delayed signals are then multiplied by respective tap weights and the resulting products summed to obtain the filtered output. Changing the effective tap weights of the pre-emphasis circuitry employing LUT 300 requires all the table entries (filter parameters) be changed, so reducing the number of entries speeds the process of changing filter characteristics. This efficiency is particularly important in adaptive pre-emphasis schemes in which filter characteristics should be quickly updated so as not to interfere excessively with data transmission.

FIG. 4 depicts a LUT 400, in accordance with one embodiment, that may be used in transmit pre-emphasis circuitry. LUT 400 provides sixteen unique DAC weights using a memory 405 with only eight addressable storage locations, or address locations. LUT 400 thus provides the same functionality as LUT 110 of FIG. 1 with only half the number of address locations. As a result, LUT 400 can be updated, adaptively or otherwise, more quickly than LUT 110.

In addition to memory 405, LUT 400 includes a selective inverter 410 and some complement logic 415. Inverter 410 selectively inverts each incoming data symbol D[2:0] in response to data symbol D[3], while complement logic 415 selectively inverts the output data Mag+from memory 405 in response to the same symbol D[3]. In this example, complement logic 415 includes a multiplexer 417, the input ports of which are coupled directly to the data output port of memory 405 and to the output port of memory 405 via some negating logic 420. Negating logic 420 calculates the negative (e.g., two's complement) of the output from memory 405, so that multiplexer 417 selectively issues either the contents of an address location of memory 405 or its complement.

In operation, LUT 400 uses three data symbols D[2:0] to address memory 405 and the fourth data symbol D[3] to select the polarities of the address signals A[2:0] and the output of LUT 400. The result is logically identical to the depiction of FIG. 3, providing sixteen addressed output signals using only eight address locations. Consider the case in which data symbols D[3:0]=0100. Because D[3 ]=0, selective inverter 410 provides symbols D[2:0] uninverted to respective address lines A[2:0] of memory 405, so that memory 405 outputs the contents of address location 100 (+Mag4) on output bus Mag+. Multiplexer 417 selects this output in response to symbol D[3], so LUT 400 conveys +Mag4 on bus DAC (DAC =+Mag4). This output is logically consistent with the model of FIG. 3, in which address location 0100 stores the value +Mag4.

Now consider the case in which data symbols D[3:0]=1011, the compliment of the data symbols in the last example. Because D[3]=1, selective inverter 410 inverts symbols D[2:0], so that memory 405 outputs the contents of address location 100 (+Mag4) on output bus Mag+. Multiplexer 417 selects the complement of this output in response to symbol D[3], so LUT 400 conveys −Mag4 on bus DAC (DAC =−Mag4). Once again, this output is logically consistent with the model of FIG. 3, in which address location 1011 stores the value −Mag4.

The function of logic 420 is not limited to two's complement, or even to complements at all, but can be modified if desired to accomplish some other suitable logical function. In other embodiments, the polarity and address selections are provided by a different data symbols or collections of data symbols. For example, if the amount of pre-emphasis (i.e. the DAC or MAG value) required to account for the ISI associated with a particular data pattern bears some recognizable relationship to one or more other data patterns, then logic 420 can be designed to leverage that relationship such that memory 405 need not be large enough to accommodate a unique DAC value for each unique set of data symbols D[3:0].

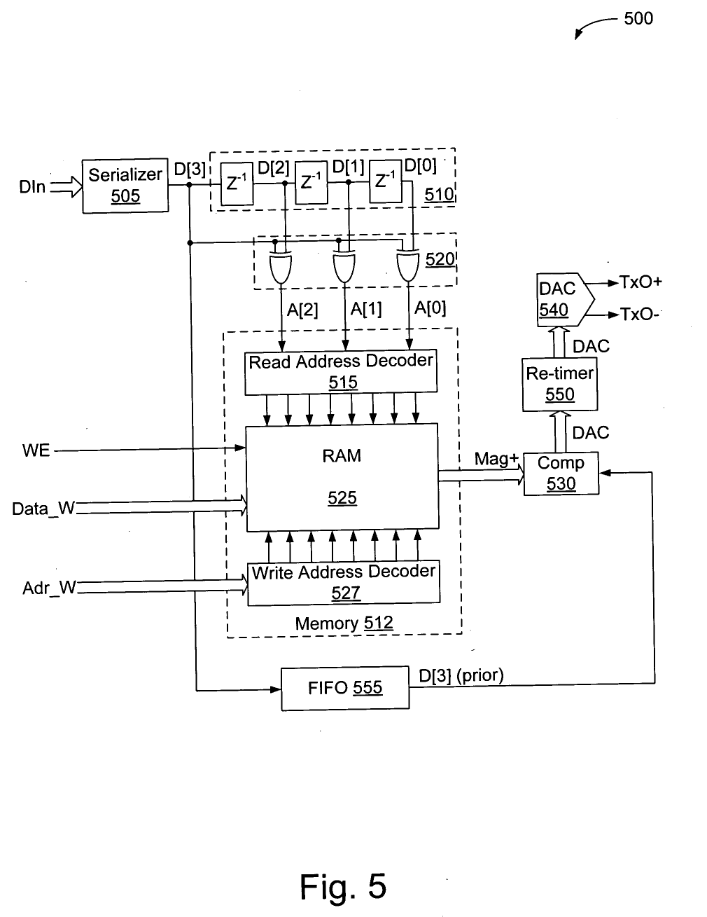

FIG. 5 depicts a transmitter 500 in accordance with another embodiment. Transmitter 500 receives parallel data Din in this embodiment, and thus includes a serializer 505. Transmitter 500 additionally includes three sequential storage elements 510 that store adjacent symbols. In other embodiments, the pre-emphasis may be based upon more or fewer symbols, the symbols may be pre-tap, post-tap, or both, and not all the symbols need be adjacent.

Transmitter 500 includes a memory 512, which in turn includes a read-address decoder 515, some RAM 525, and a write-address decoder 527. Filter parameters are loaded into memory 512 by asserting a write-enable signal WE while presenting write data/address pairs on data and address busses Data_W and Adr_W.

Storage elements 510 feed address decoder 515 via a selective inverter 520 that selectively inverts data symbols D[2:0] as directed by symbol D[3]. Address decoder 515 decodes the three symbols from selective inverter 520 to select one of eight (2³) address lines to a RAM 525. The contents of RAM 525 are conveyed to complement logic 530 that selectively provides, at the direction of symbol D[3], the filter coefficient of an addressed memory location or the complement of the filter coefficient. A FIFO 555 matches the delay between node D[3] and logic 530 to the combined delay through decoder 515 and RAM 525. Alternatively, one of symbols D[2:0] can be used to control logic 530. If, for example, two clock cycles of delay are required to match the delay between node D[3] and complement logic 530 to the combined delay through decoder 515 and RAM 525, then FIFO 555 can be omitted in favor of controlling complement logic 530 with data symbol D[1].

Complement logic 530 delivers the appropriate filter coefficient, or a complement thereof, to a DAC 540 that converts the digital magnitude of the coefficient or its complement into an analog output signal TxO+/TxO− to be applied to an associated communication link (not shown). A re-timer 550 may be included, if needed, to retime signal DAC with the transmit clock. In some embodiments complement logic 530 is integrated with DAC 540, such that DAC 540 interprets the output from RAM 525 based upon the value of a delayed version of symbol D[3].

Adaptive Memory Update

Adaptive transmit pre-emphasis may be used for marginal links or links whose transfer characteristic change over time. In either case, the received signal quality is typically measured at the receiver. Measures of signal quality, such as the bit-error rate or symbol amplitude, can be used to alter the pre-emphasis filter coefficients. In the examples of FIGS. 1-5, changing the filter coefficients typically requires all address locations be modified. Unfortunately, the speed at which the memories can be written to is generally slower than the read speed, and updating the memory with new coefficients interferes with data transmission. Transmitters in accordance with some embodiments address this problem by facilitating memory updates that do not interfere with data transmission.

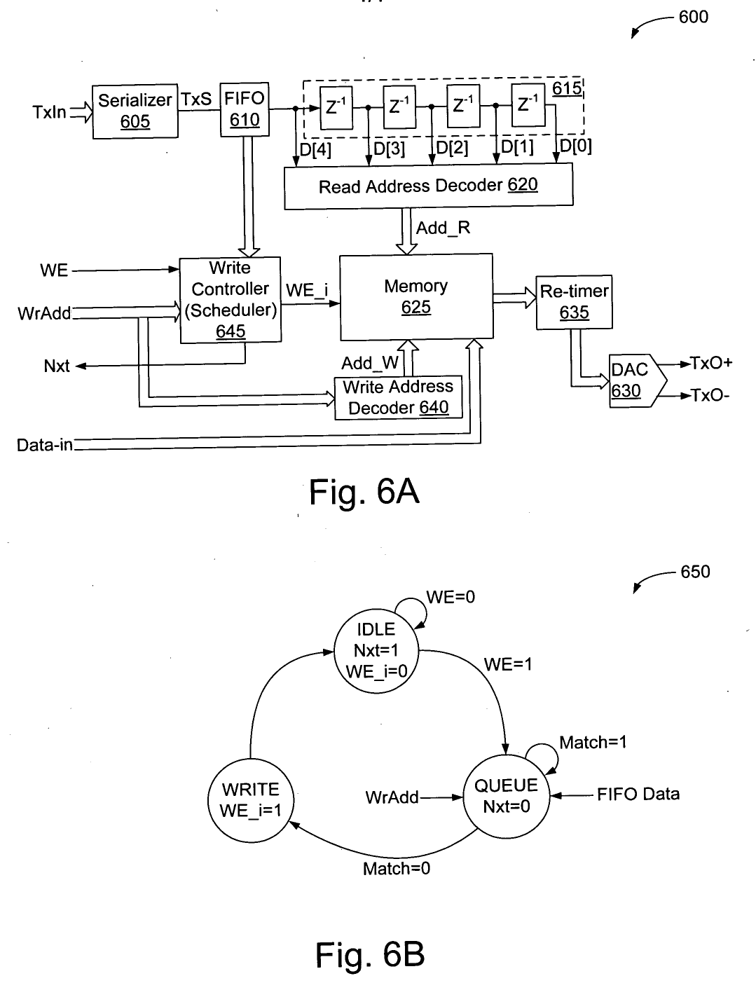

FIG. 6A depicts an embodiment of a transmitter 600 with a pre-emphasis filter that can be updated adaptively without interfering with data transmission. Transmitter 600 includes a serializer 605 that converts parallel data TxIn into serial data TxS. Serial data TxS is then conveyed via a first-in-first-out (FIFO) buffer 610 and a series of sequential storage elements 615 to a read-address decoder 620 associated with a memory 625, a RAM in this example. Five bits D[4:0] of serial data TxS thus periodically provide addresses Add_R. In response, memory 625 periodically issues digital values from the addressed storage locations to a DAC 630, in some embodiment by way of a re-timer 635.

Transmitter 600 includes additional elements to support adaptive memory updates with no or minimal interference with data transmission. To do this, transmitter 600 is equipped with FIFO 610 and a write controller 645 that together schedule updates to memory 625 (writes) so that address locations within memory 625 are not read from and written to simultaneously. In essence, write controller 645 distinguishes between address locations within memory 625 that are to be read from within a predetermined time insufficient to allow for a write cycle (i.e., active address locations) from inactive address locations, and schedules write cycles only for inactive address locations. Conversely stated, write controller 645 bars write operations to active address locations. Write controller 645 monitors write addresses WrAdd provided to an address decoder 640, but may also be adapted to monitor address signals Add_W from decoder 640 to memory 625.

In some embodiments, memory 625 is optimized for fast reads, with writing being somewhat slower. In such embodiments, the write controller can be designed to monitor the output of FIFO 610 to find time windows of sufficient length to affect a write cycle for a given address location. Assuming, for example, that the contents of address location 11011 is to be updated, write controller 645 monitors the output from FIFO 610 until that address does not appear for a write storage time T long enough to accomplish a write operation (i.e., the corresponding address location is not to be read from in the near future, and is thus inactive), and then asserts an internal write-enable signal WE_i to initiate a write to that inactive location. At a given instant, an active storage location is one that is either being read from currently or will be read from before the expiration of the write storage time from the instant.

Once the write is completed, scheduler issues a next-address signal Nxt indicating that controller 645 is ready for another write address, if any. Though not shown here, write controller 645 receives write addresses and write-enable signals WE from some control logic that calculates new filter parameters and conveys them to transmitter 600. The control logic withholds new input data Data-in and the corresponding write address WrAdd pending receipt of signal Nxt from controller 645.

Storage elements 615 make up a FIFO buffer, and one or more data bits from elements 615 can be used instead of or to supplement FIFO 610. In one embodiment, for example, write controller 645 receives data bit D[6] directly from serializer 605, data bits D[5:4] from FIFO 610, and data bits D[1:3] from elements 615.

FIG. 6B is a state diagram 650 illustrating the operation of transmitter 600 of FIG. 6A in accordance with one embodiment. In an idle state IDLE, write controller 645 sets internal write-enable signal WE_i to zero and asserts next signal Nxt to express readiness to receive new address and data signals on respective ports WrAdd and Data-in. A source (not shown) of new filter parameters initiates a write to memory 625 by providing a filter parameter on bus Data_W and then asserting the write-enable signal (WE=1) only if signal Nxt is one. In response to the asserted write-enable signal, the flow of state diagram 650 moves to a queue state QUEUE in which the contents of FIFO 610 are compared with the write address on port WrAdd and signal Nxt is deasserted.

The process remains in the queue state until the address to be written does not match one or a series of patterns in FIFO 610. If, for example, a write cycle requires two clock periods, write controller 645 asserts an internal match signal (Match=1) if either of two consecutive data patterns to be presented to decoder 620 matches the write address on port WrAdd, and otherwise deasserts the match signal. An asserted match signal identifies a potential conflict, so write controller 645 remains in the QUEUE state until the deasserted match signal identifies a write window. The process then moves to a write state WRITE, in which controller 645 asserts the internal write enable signal WE_i, thus causing memory 625 to write the new filter parameter on data bus Data_W into the address location specified on address bus WrAdd. Write state WRITE delays the write cycle by a number of clock cycles to synchronize the write cycle with identified time window. In FIG. 6A, for example, the leading pattern in a data window identified in FIFO 610 as not including a match for the current write address is allowed to load into elements 615 before write-enable signal WE_i is asserted. Once again in the idle state, write controller 645 deasserts internal write-enable signal WE_i and indicates readiness to receive a new address/data pair by asserting signal Nxt.

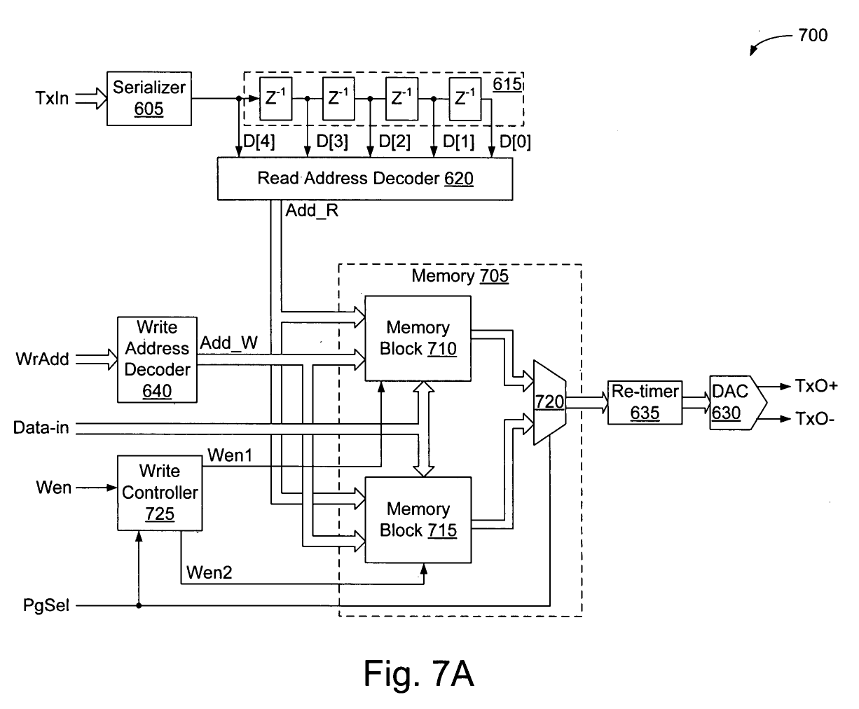

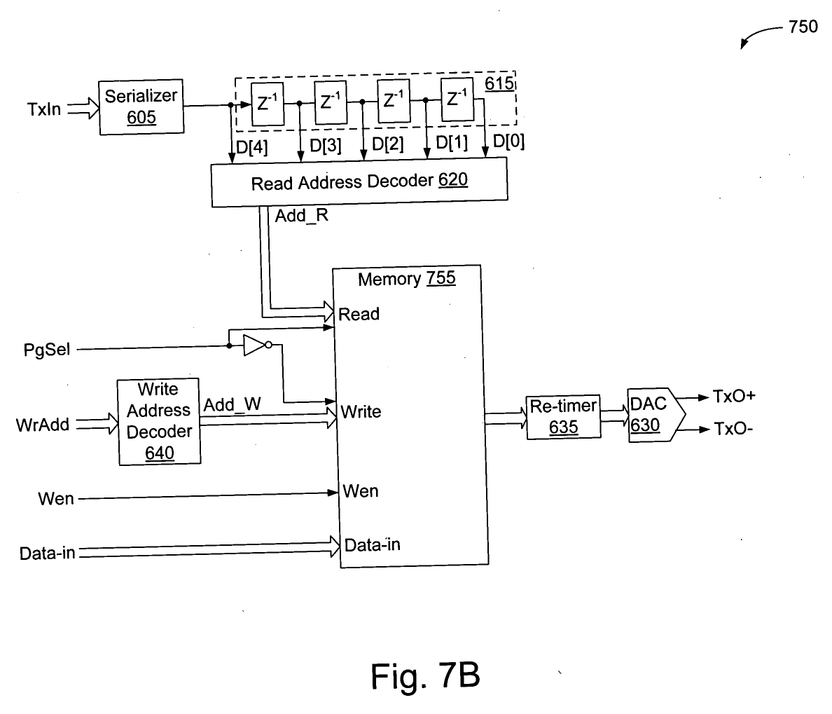

FIG. 7A depicts a transmitter 700 in accordance with another embodiment. Transmitter 700 is in many ways similar to transmitter 600 of FIG. 6, like-numbered elements being the same or similar. In place of FIFO 610 and controller 645, however, transmitter 700 employs a memory 705 and write controller 725. Memory 705 is divided into two identical memory blocks 710 and 715, with separate write-enable nodes Wen1 and Wen2, and includes a multiplexer 720 to select between them. Write controller 725 issues one of a pair of write-enable signals Wen2 and Wen2 in response to a common write-enable signal Wen. A page select signal PgSel determines which of write-enable signals Wen1 and Wen2 is asserted.

The output of transmitter 700 can be taken from either of memory blocks 710 and 715 by setting a page-select signal PgSel either high or low. The filter parameters of transmitter 700 are easily changed by updating the inactive one of blocks 710 and 715 with the new filter values and then selecting the output from the updated block. Write controller 725 only enables writes to the inactive one of blocks 710 and 715 in response to write-enable signal Wen, so writes are prevented from interfering with address locations within the read-enabled block.

FIG. 7B depicts a transmitter 750 in accordance with another embodiment. Transmitter 750 is in many ways similar to transmitters 600 and 700 of FIGS. 6 and 7, like-numbered elements being the same or similar. Transmitter 750 uses a memory 755 with respective read and write address ports Read and Write. The page select signal PgSel is used for one read address bit, while which the inverse of page-select signal PgSel is used for the corresponding write address bit. This arrangement separates memory 755 into two address spaces, or “blocks,” the addresses of which may be interleaved. The write-enable signal Wen can be divided into separate signals depending on the organization of memory 755. Memory 755 might, for example, allow for simultaneous read and write operations to different addresses, in which case separate write-enable signals could control write access to the different addresses.

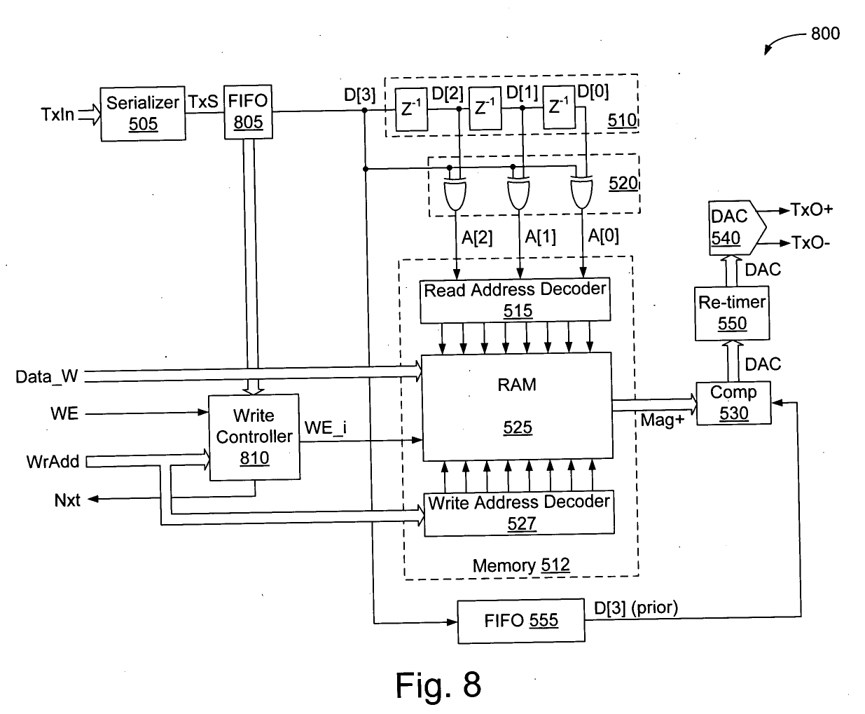

FIG. 8 depicts a transmitter 800 that combines features of some of the above-described embodiments to provide both increased memory update speed and conflict avoidance. Transmitter 800 is similar to transmitter 500 of FIG. 5, like-numbered elements being the same or similar. Transmitter 800 is adapted in a manner similar to transmitter 600 of FIG. 6 to include a FIFO 805 and write controller 810 that work in the manner described above in connection with FIG. 6 to prevent read/write contention, and thus to facilitate adaptive changes to the filter coefficients in RAM 525. The embodiments of FIG. 7A and 7B can also be adapted to include circuitry similar to that detailed above in connection with FIGS. 3-5 to reduce the requisite number of table entries.

In the foregoing description and in the accompanying drawings, specific terminology and drawing symbols are set forth to provide a thorough understanding of the present invention. In some instances, the terminology and symbols may imply specific details that are not required to practice the invention. For example, the interconnection between circuit elements or circuit blocks may be shown or described as multi-conductor or single conductor signal lines. Each of the multi-conductor signal lines may alternatively be single-conductor signal lines, and each of the single-conductor signal lines may alternatively be multi-conductor signal lines. Signals and signaling paths shown or described as being single-ended may also be differential, and vice-versa. Similarly, signals described or depicted as having active-high or active-low logic levels may have opposite logic levels in alternative embodiments. With respect to terminology, a signal is said to be “asserted” when the signal is driven to a low or high logic state (or charged to a high logic state or discharged to a low logic state) to indicate a particular condition. Conversely, a signal is said to be “de-asserted” to indicate that the signal is driven (or charged or discharged) to a state other than the asserted state (including a high or low logic state, or the floating state that may occur when the signal driving circuit is transitioned to a high impedance condition, such as an open drain or open collector condition). A signal driving circuit is said to “output” a signal to a signal receiving circuit when the signal driving circuit asserts (or de-asserts, if explicitly stated or indicated by context) the signal on a signal line coupled between the signal driving and signal receiving circuits. A signal line is said to be “activated” when a signal is asserted on the signal line, and “deactivated” when the signal is de-asserted. Whether a given signal is an active low or an active high will be evident to those of skill in the art.

An output of a process for designing an integrated circuit, or a portion of an integrated circuit, comprising one or more of the circuits described herein may be a computer-readable medium such as, for example, a magnetic tape or an optical or magnetic disk. The computer-readable medium may be encoded with data structures or other information describing circuitry that may be physically instantiated as an integrated circuit or portion of an integrated circuit. Although various formats may be used for such encoding, these data structures are commonly written in Caltech Intermediate Format (CIF), Calma GDS II Stream Format (GDSII), or Electronic Design Interchange Format (EDIF). Those of skill in the art of integrated circuit design can develop such data structures from schematic diagrams of the type detailed above and the corresponding descriptions and encode the data structures on computer readable medium. Those of skill in the art of integrated circuit fabrication can use such encoded data to fabricate integrated circuits comprising one or more of the circuits described herein.

While the present invention has been described in connection with specific embodiments, variations of these embodiments will be obvious to those of ordinary skill in the art. For example, embodiments of the invention may be adapted for use with multi-pulse-amplitude-modulated (multi-PAM) signals. Moreover, some components are shown directly connected to one another while others are shown connected via intermediate components. In each instance the method of interconnection, or “coupling,” establishes some desired electrical communication between two or more circuit nodes, or terminals. Such coupling may often be accomplished using a number of circuit configurations, as will be understood by those of skill in the art. Therefore, the spirit and scope of the appended claims should not be limited to the foregoing description. Only those claims specifically reciting “means for” or “step for” should be construed in the manner required under the sixth paragraph of 35 U.S.C. Section 112.

What is claimed is:

1. A transmitter comprising:
a. a data-input port;
b. a sequential storage element coupled in series with the data-input port;
c. a memory having:
i. a plurality of addressable storage locations, including at least one active storage location and at least one inactive storage location; and
ii. a read-address port coupled to the at least one sequential storage element;
d. a digital-to-analog converter (DAC) coupled to the memory; and
e. a write controller coupled to the memory to bar write operations to the active storage location.

2. The transmitter of claim 1, wherein a write operation to one of the storage locations requires a write storage time, and wherein the active storage location, at a given instant, will be read from before the expiration of the write storage time from the instant.

3. The transmitter of claim 1, further comprising a first-in-first-out (FIFO) buffer coupled in series with the sequential storage element.

4. The transmitter of claim 3, wherein the FIFO buffer includes at least one output terminal coupled to the write controller.

5. The transmitter of claim 1, further comprising a read-address decoder, wherein the read-address port is coupled to the sequential storage element via the read-address decoder.

6. The transmitter of claim 1, wherein the inactive memory locations are part of a first memory block with a first write-enable terminal and the active memory locations are part of a second memory block with a second write-enable terminal.

7. The transmitter of claim 6, wherein the memory includes a memory output port, a multiplexer having a first multiplexer input port coupled to the first memory block, a second multiplexer input port coupled to the second memory block, and a multiplexer output port coupled to the memory output port.

8. The transmitter of claim 1, further comprising a re-timer disposed between the memory and the DAC.

9. The transmitter of claim 1, further comprising a selective inverter, wherein the read-address port is coupled to the at least one sequential storage element via the selective inverter.

10. The transmitter of claim 9, further comprising complement logic coupled to the memory and the DAC.

11. The transmitter of claim 10, wherein the complement logic further comprises a control terminal coupled to a select node of the selective inverter.

12. The transmitter of claim 9, wherein the memory includes a memory output port, the DAC includes a DAC input port, and wherein the transmitter further comprises complement logic having an input port coupled to the memory output port and an output port coupled to the DAC input port.

13. A method of transmitting serial data, the method comprising:
a. loading each of a plurality of memory locations with a corresponding one of a plurality of digital filter parameters;
b. identifying ones of the memory location to be read within a period T as an active address location and others of the memory locations as inactive address locations;
c. converting the serial data into parallel data symbols;
d. periodically addressing the memory locations using the parallel data symbols;
e. receiving a new digital filter parameter;
f. loading the new digital filter parameter into a selected one of the inactive address locations while addressing at least one of the active address locations; and
g. activating the selected one of the inactive address locations loaded with the new digital filter parameter.

14. The method of claim 13, wherein identifying the inactive address locations includes monitoring the serial data for data patterns.

15. The method of claim 13, wherein the active address locations are part of a first block of the memory locations responding to a first write-enable signal and the inactive address locations are part of a second block of the memory locations responding to a second write-enable signal.

16. The method of claim 13, further comprising selectively inverting ones of the parallel data symbols based upon another of the parallel data symbols.

17. The method of claim 16, wherein periodically addressing the memory locations using the parallel data symbols addresses the memory locations using the selectively inverted ones of the parallel data symbols.

18. The method of claim 16, further comprising selectively inverting a ones of the digital filter parameters from addressed memory locations.

19. The method of claim 16, further comprising selectively inverting one of the digital filter parameters from an addressed one of the memory locations based upon another of the parallel data symbols.

20. A transmitter comprising:
a. a data-input port;
b. at least one sequential storage element coupled in series with the data-input port;
c. a memory having:
i. a plurality of addressable storage locations; and
ii. a read-address port coupled to the at least one sequential storage element;
d. a digital-to-analog converter (DAC) coupled to the memory; and
e. means for simultaneously reading from and writing to the memory.

21. The transmitter of claim 20, wherein the means for simultaneously reading from and writing to the memory keeps track of active memory locations and inactive memory locations.

22. The transmitter of claim 20, wherein the at least one sequential storage element includes at least one active storage location and at least one inactive storage location and the means for simultaneously reading from and writing to the memory includes means for barring write operations to active storage locations

23. The transmitter of claim 20, further comprising a selective inverter, wherein the read-address port is coupled to the at least one sequential storage element via the selective inverter.

24. A computer-readable medium having stored thereon a data structure defining a transmitter adapted to transmit an input signal expressed as a sequence of data symbols, the data structure comprising:
a. first data describing a data-input port;
b. second data describing at least one sequential storage element coupled in series with the data-input port;
c. third data describing a memory having:
i. a read-address port coupled to the at least one sequential storage element;
ii. a write-address port;
iii. a memory input port; and
iv. a memory output port;
d. fourth data describing a multiplexer having a multiplexer input port coupled to the output port, a select port coupled to the data-input port, and a multiplexer output port; and
e. fifth data describing a digital-to-analog converter (DAC) having a DAC input port coupled to the multiplexer output port and a DAC output port coupled to the communication channel.

25. A transmitter comprising:
a. a data-input port;
b. a sequential storage element coupled in series with the data-input port;
c. a memory having a plurality of address locations, including an active address location and an inactive address location, wherein the active address location will be read from within a predetermined time insufficient to allow for a write cycle; and
d. a write controller coupled to the memory, wherein the write controller bars a write operation to the active storage location.

26. The transmitter of claim 25, wherein the write operation requires a time T, and wherein the inactive storage location is, at a given instant, one of the plurality of addressable storage locations that will not be read for the time T.

27. The transmitter of claim 25, further comprising a first-in-first-out (FIFO) buffer coupled in series with the sequential storage element.

28. The transmitter of claim 27, wherein the FIFO buffer includes at least one output terminal coupled to the write controller.

29. The transmitter of claim 25, wherein the inactive memory locations are part of a first memory block with a first write-enable terminal and the active memory locations are part of a second memory block with a second write-enable terminal.
